(19) United States
(12) Patent Application Publication
(10) Pub. No.: US 2008/0013054 A1
(43) Pub. Date: Jan. 17, 2008

(54) PROJECTION DEVICE

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/769,843

(22) Filed: Jun. 28, 2007

(30) Foreign Application Priority Data
Jun. 30, 2006 (JP) 2006-180606

(51) Int. Cl. G03B 21/28

(52) U.S. Cl. 353/99

(57) ABSTRACT

There is provided a projection device provided with an upright screen, an image projection unit configured to emit light carrying an image to be projected. The image projection unit emits the light toward the upright screen. A first mirror, a second mirror and a third mirror are provided. The light emitted by the image projection unit is reflected by the first, second and third mirrors in this order, and is projected on the upright screen from its behind. An optical path, in a cross section taken on a plane which extends vertically, perpendicular to the upright screen and intersecting with the upright screen at the center thereof, between the second mirror and the third mirror, of a light ray that is incident on the lowermost position of the upright screen is substantially parallel to the upright screen.

### BACKGROUND OF THE INVENTION

The present invention relates to an oblique projection type projection device configured to project a source image on a screen by obliquely projecting light carrying the image to be projected on a screen.

An oblique projection type projection device capable of projecting an image on a screen by obliquely projecting light carrying the image without trapezoidal distortion is well known. The oblique projection device is particularly advantageous for reducing a size of a rear-projection device, which is configured to project an image from a rear side of a screen. The displayed image is viewed on a front side of the screen. Hereinafter, throughout the specification, a term “the projection device” will be used to refer to “the oblique projection type projection device”.

The projection device is generally provided with a projection optical system, at least one mirror, and a screen. The projection optical system is configured to emit light carrying an image to be projected on the screen. The light emitted from the projection optical system is deflected by the at least one mirror and is directed toward the screen. The at least one mirror may be arranged to face the rear side of the screen. However, in such a configuration, ambient light may be incident on the mirror due to a light entered through the screen from outside and reflected thereby, resulting in stray light inside the projection device.

To avoid the above condition, the mirror may be arranged on an inner surface of a top panel of the projection device. An example of such a projection device is disclosed in Japanese Patent Provisional Publication No. 2005-43681 (hereinafter, referred to as '681 publication).

Generally, in the oblique-projection type projection device, various aberrations (e.g., distortion, etc.) should be cancelled. For this purpose, an aspherical mirror may be arranged on an optical path from the projection optical system to the screen. According to the configuration disclosed in '681 publication, however, there is no sufficient space to arrange the additional optical elements (e.g., the aspherical mirror) to compensate for the aberrations inside of the projection device. In order to introduce such an optical element for compensation, the projection device needs to be upsized to make room therefor.

### SUMMARY OF THE INVENTION

The present invention is advantageous in that a projection device in which optical elements necessary for compensating for various aberrations can be employed without increasing its size is provided.

According to aspects of the invention, there is provided a projection device which is provided with an upright screen, an image projection unit configured to emit light carrying an image to be projected on the upright screen. The image projection unit is arranged behind a lower portion of the upright screen and emits the light toward the upright screen. A first mirror, a second mirror and a third mirror are provided. The light emitted by the image projection unit is reflected by the first, second and third mirrors in this order, and is projected on the upright screen from its behind. The first mirror is arranged to reflect the light emitted by the image projection unit such that the reflected light proceeds in a direction away from the screen. The second mirror is arranged to reflect the light reflected by the first mirror toward an upper wall of the projection device. The third mirror is arranged on an inner surface of the upper wall of the projection device. An optical path, in a cross section taken on a plane which extends vertically, perpendicular to the upright screen and intersecting with the upright screen at the center thereof, between the second mirror and the third mirror, of a light ray that is incident on the lowermost position of the upright screen is substantially parallel to the upright screen.

Optionally, the second mirror may be configured to compensate for aberrations.

Optionally, an angle between the third mirror and a normal to the upright screen may be set to (θ/2)±1 degrees, where θ represents an angle formed between the upright screen and the lowermost light ray incident on the upright screen.

Optionally, the projection device may be configured to satisfy a condition:

(i−m)cos ω≦h,

where, i represents an optical path length, on the cross section, of a light ray incident on the uppermost position on the upright screen, from an exit pupil of the image projection unit to the third mirror, m represents an optical path length, on the cross section, of the light ray that is incident on the lowermost position on the upright screen, from an exit pupil of the image projection unit to the third mirror, ω represents an difference of an angle formed between the upright screen and the light ray incident on the uppermost position on the upright screen, and an angle formed between the upright screen and the light ray incident on the lowermost position on the upright screen, and h represent a height of the upright screen.

Further optionally, the projection device may be configured to satisfy a following condition:

$$\frac{h}{\frac{i sin ω}{tan 2 α} - \frac{m sin ω}{tan α} + h} \leq \frac{\frac{1}{tan ( α - \frac{ω}{2} )} + \frac{1}{tan ω}}{\frac{1}{tan 2 α} + \frac{1}{tan ω}}$$

where, i represents an optical path length, on the cross section, of a light ray incident on the uppermost position on the upright screen, from an exit pupil of the image projection unit to the third mirror,

m represents an optical path length, on the cross section, of the light ray that is incident on the lowermost position on the upright screen, from an exit pupil of the image projection unit to the third mirror,

ω represents an difference of an angle formed between the upright screen and the light ray incident on the uppermost position on the upright screen, and an angle formed between the upright screen and the light ray incident on the lowermost position on the upright screen,

h represent a height of the upright screen, and

α represents an angle, on the cress section, between the second mirror and the light ray, that is incident on the lowermost position on the upright screen, incident on the second mirror.

In the projection device, the first mirror and the third mirror may be planar mirrors. Further, the second mirror may be an aspherical mirror.

The second mirror may be configured such that, within an area on which the light reflected by the first mirror is incident, the shape of the second mirror, in the cross section, is linear, and the shape of the second mirror, on a plane parallel with the upright screen is curved toward a direction in which the light by the second mirror proceeds.

Alternatively, the second mirror may be configured such that, within an area on which the light reflected by the first mirror is incident, the shape of the second mirror, in the cross section, is linear, and the shape of the second mirror, on a plane parallel with the upright screen is curved toward a direction opposite to a direction in which the light reflected by the second mirror proceeds.

### BRIEF DESCRIPTION OF THE ACCOMPANYING DRAWINGS

FIG. 1 is a cross-sectional side view showing a structure of a projection device according to a present invention.

FIG. 2 is a schematic diagram for illustrating an arrangement of optical elements of the projection device according to the present invention, in which an optical path in the projection device is partially developed.

FIG. 3 is a schematic diagram for illustrating an arrangement of optical elements of the projection device according to the present invention, in which an optical path in the projection device is entirely developed.

FIG. 4 is a simplified cross-sectional side view showing a structure of a projection device according to a present invention.

FIG. 5 is a schematic diagram showing an arrangement of optical elements of the projection device according to a modification example, in which an optical path in the projection device is entirely developed.

FIG. 6 is a table showing the specific parameters of projection devices in FIG. 4.

### DETAILED DESCRIPTION OF THE EMBODIMENTS

Referring now to the accompanying drawings, a description will be given in detail of an illustrative embodiment in accordance with the present invention.

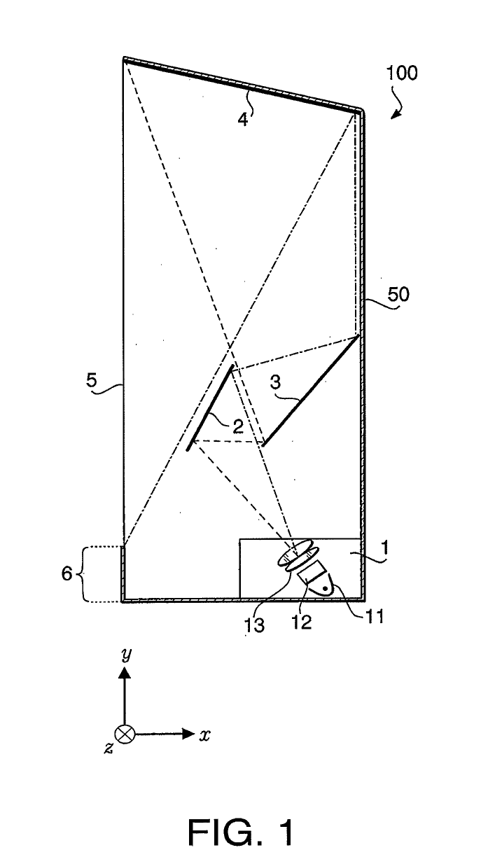

FIG. 1 schematically shows a cross-sectional side view of a projection device 100, used in a normal state, according to the present invention. Incidentally, “the normal state” referred hereinafter means a state where the projection device is placed such that a bottom surface of the projection device faces a ground surface. According to the illustrative embodiments, the projecting device is configured such that a plane of the screen is perpendicular to the ground surface (i.e., vertically extends). In the following description, directions will be described when the projection device is placed in the normal state. The projection device 100 is provided with a projection optical unit 1, a first planar mirror 2, an aspherical mirror 3, a second planar mirror 4 and an upright screen 5, which are arranged in a casing 50.

As shown in FIG. 1, when the projection device 100 is in the normal state, an X direction refers to a thickness direction of the screen 5, a Y direction refers to a vertical direction, and a Z direction refers to a horizontal direction, in the following description. Additionally, lengths of the projection device in X direction, Y direction and Z direction are referred to as a depth, a height and a width, respectively. FIG. 1 is a cross-sectional side view taken along the X-Y plane. It is noted that all the drawings and descriptions hereinafter are based on the cross-sectional side views taken along the X-Y plane at the center of the screen 5 in the Y direction, unless otherwise mentioned.

The projection optical unit 1 is provided with a light source 11, an image source unit 12 including a transmissive liquid crystal display (LCD), and an projection optical system 13. The projection optical unit 1 is arranged adjacent to a rear wall and a bottom wall of the projection device 100. The projection optical unit 1 emits a light, which passed through the transmissive LCD and thereby carrying an image to be projected. Incidentally, while the projection optical system 13 shown in FIG. 1 has two lenses for brevity, the projection optical system 13 may have more lenses.

The light emitted from the projection optical unit 1 is divergent light and incident on the first planar mirror 2. The first planar mirror 2 reflects the incident light in a direction away from the screen 5 and toward the aspherical mirror 3.

It is noted that the projection device may be configured such that the first planar mirror 2 is omitted and the aspherical mirror 3 is arranged in a different manner so that the light emitted from the projection optical unit 1 directly incident on the aspherical mirror 3 and then directed to the second planar mirror. However, in such configuration, a distance between the aspherical mirror 3 and the projection optical unit 1 should be made small in order to keep the size of the projection device 100 relatively small. In such a configuration, it is difficult to provide a sufficiently long optical path for correcting the aberration using the aspherical mirror 3 and projecting a source image on the entire area of the screen 5. In order to avoid the above problem, the first planar mirror 2 is to be provided.

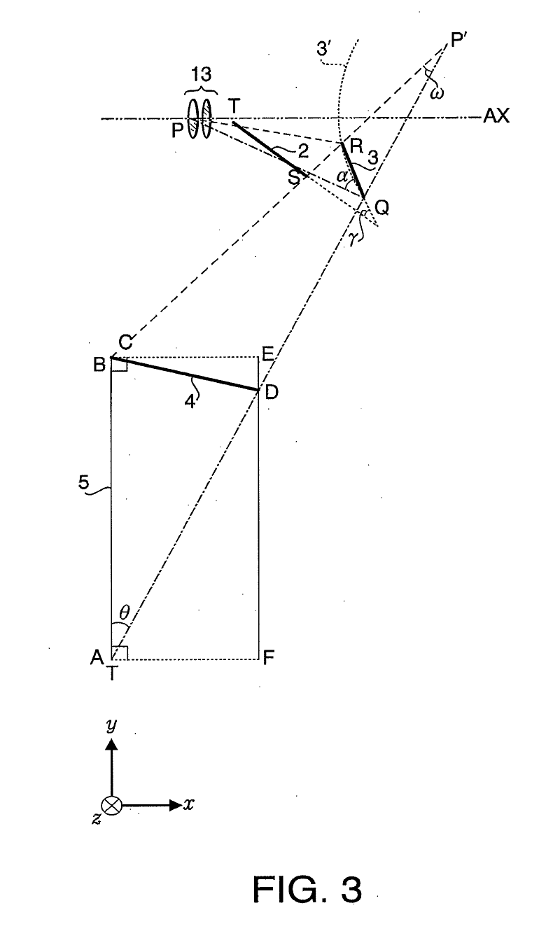

The aspherical mirror 3 is configured to have a shape for compensating for various aberrations (e.g., trapezoidal distortion) which cannot be compensated by the projection optical system 13. The shape of the aspherical mirror 3 is designed depending on a residual aberration which cannot be compensated for by the projection optical system 13. Generally, in the oblique projection device, a barrel-shaped distortion is likely to occur. Therefore, the aspherical mirror 3 in the present embodiment may have a shape which is a marginal part of a convex mirror (see 3′ in FIG. 3). Specifically, the shape of the aspherical mirror 3 is substantially linear on the X-Y plane and curved toward the incident light on the Y-Z plane. The aspherical mirror 3 reflects the incident light upward (i.e., toward the top panel) of the projection device 100. The arrangement of the planar mirror 2 and the aspherical mirror 3 will be described later.

The second planar mirror 4 is fixed on the inner top surface of the casing 50 such that it inclines by a predetermined angle with respect to the X-Z plane. The second planar mirror 4 reflects the light toward the screen 5, thereby an image is projected on the screen 5. Accordingly, a user can view the image from the front side (i.e., left-hand side in FIG. 1) of the screen 5.

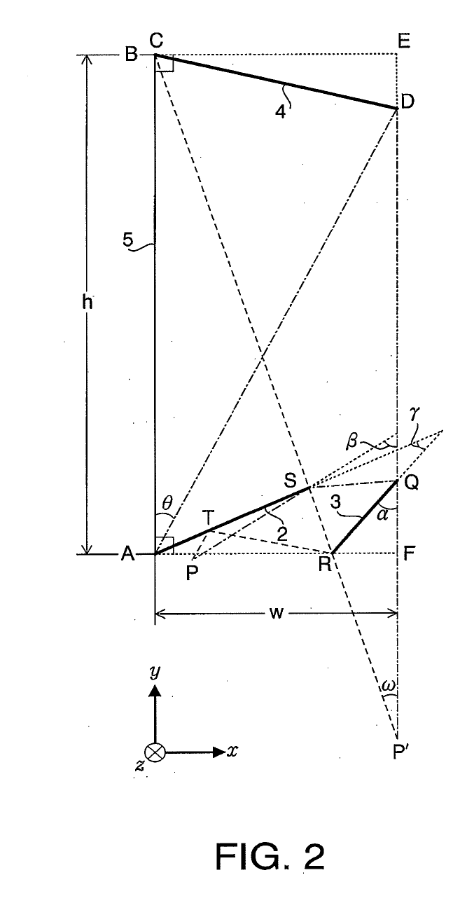

Hereinafter, the arrangement of the first planar mirror 2 and the aspherical mirror 3 will be described in detail. FIG. 2 is a schematic diagram illustrating a preferred arrangement of the first planar mirror 2 and the aspherical mirror 3 enabling downsizing of the projection device 100 in a manner where the optical path is partially developed. FIG. 3 is a schematic diagram in which the entire optical path is developed. It should be noted that FIGS. 2 and 3 shows diagrams are provided for illustrating purpose and do not show the configuration of the embodiment shown in FIG. 1, 4 or 5. In each FIGS. 1, 2 or 3, a ray of light incident on a lowermost part of the screen 5 is indicated by a dotted line and hereinafter referred to as a “lowermost incident ray”. A ray of light incident on an uppermost part of the screen 5 is indicated by a broken line and hereinafter referred to as an “uppermost incident ray”. The optical center AX of the projection optical system 13 is indicated in a dashed-two dotted line in FIG. 3.

Symbols shown in FIGS. 2 and 3 are defined as follows.

A . . . A lowermost position of the screen 5.

B . . . An uppermost position of the screen 5.

C . . . A screen side edge of the second planar mirror 4. This edge corresponds to a position on which the uppermost incident ray is incident.

D . . . The opposite edge of the second planar mirror 4. This edge corresponds to a position on which the lowermost incident ray is incident.

E . . . An intersection of a normal to the screen 5 extended from point B, with an extended line of the optical path of the lowermost incident ray reflected by the aspherical mirror 3.

F . . . An intersection of a normal to the screen 5 extended from point A, with an extended line of the optical path of the lowermost incident ray reflected by the aspherical mirror 3.

P . . . A position of an exit pupil of the projection optical system 13.

P′ . . . A position corresponding to the position P, when the optical path reflected by the first planar mirror 2 and the aspherical mirror 3 is developed, assuming that the aspherical mirror 3 is a planar mirror.

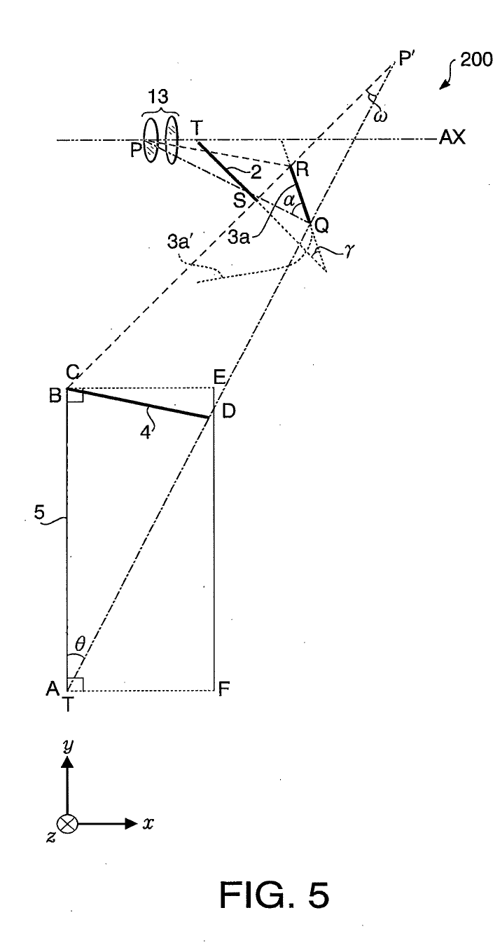

Q . . . An incident position of the lowermost incident ray on the aspherical mirror 3, which is the farthest point from the optical center AX of the projection optical system 13 on the aspherical mirror 3 in FIG. 3 and FIG. 5.

R . . . An incident position of the uppermost incident ray on the aspherical mirror 3, which is the closest point from the optical center AX of the projection optical system 13 on the aspherical mirror 3 in FIG. 3 and FIG. 5.

S . . . An incident position of the lowermost incident ray on the first planar mirror 2.

T . . . An incident position of the uppermost incident ray on the first planar mirror 2.

θ . . . An angle between the screen 5 and the lowermost incident ray directed to the screen 5.

ω . . . A difference between the angle θ, and an angle formed between the screen 5 and the uppermost incident ray directed to the screen 5. It is noted that the ω always has a positive value.

α . . . An angle between the aspherical mirror 3 and the lowermost incident ray directed to the aspherical mirror 3.

Incidentally, each angle defined above and in the following description is an acute angle and indicated in a unit of “degree”. Therefore, the angle θ is ∠BAD, the angle ω is ∠BP′D, and the angle α is ∠SQR in FIG. 2 and 3. Since the optical path of FIG. 2 is partially developed, the line segment QD and the line segment FQ may be considered to be on the same line. Therefore, the angle a is represented as ∠FQR in FIG. 2. If the angle a is equal to an angle between the aspherical mirror 3 and the screen 5, the lowermost incident ray, which is reflected by the aspherical mirror 3 and incident on the second planar mirror 4, proceeds in parallel to the screen 5. In such a case, the projection device 100 may further be downsized.

Incidentally, a dotted line 3′ in FIG. 3 shows a cross sectional shape of the convex mirror, which shows a base curve, on the X-Y plane, of the aspherical mirror 3. As described above, in FIG. 3, the aspherical mirror 3 has a shape which is the marginal part of the convex mirror represented by the dotted line 3′.

In order to keep the size of the projection device 100 relatively small, a sufficient space to arrange the first planar mirror 2 and the aspherical mirror 3 should be formed without blocking the optical path. In order to have the sufficient space, each element is arranged such that the lowermost incident ray reflected by the aspherical mirror 3 proceeds in a direction substantially parallel to the screen 5.

Specifically, when the proceeding direction of the lowermost incident ray reflected by the aspherical mirror 3 is parallel to the screen 5, the angle θ is represented by a following formula (1).

∠ADQ=∠BAD=0 (1)

Formula (2) is derived from formula (1).

∠ECD=½×∠ADQ=θ/2 (2)

According to formula (2), when the proceeding direction of the lowermost incident ray reflected by the aspherical mirror 3 is parallel to the screen 5, the second planar mirror 4 is arranged such that an angle between the second planar mirror 4 and the normal CE to the screen 5 is θ/2 (i.e. an angle between the second panel mirror 4 and the screen 5 is (90−θ/2) degrees). It is noted that the second planar mirror 4 is arranged such that the angle between the second planar mirror 4 and the normal CE is (θ/2)±1 degrees in the actual device, in consideration of the individual difference of each mirror and other effects.

In the configuration shown in FIG. 2, the point R is arranged on the line AF and the point S is arranged on the line CR (or line CP′). Additionally, an extension of the line segment ST is made coincide with the point A in the embodiment. That is, the lowermost edges of the first planar mirror 2 and the aspherical mirror 3 are arranged to be very close to the X-Z plane including the lowermost position of the screen 5. With the above configuration, an effective area (an area to which the light carrying the image is incident) of the first planar mirror 2 and an effective area of the aspherical mirror 3 can be maintained relatively small, which enables downsizing of the first planar mirror 2 and the aspherical mirror 3. Additionally, degree of freedom in arranging the first planar mirror 2 can be enhanced.

The first planar mirror 2 is inclined such that the point S is farther from the screen 5 than the point T in the X direction. The aspherical mirror 3 is inclined so that the point Q is farther from the screen 5 than the point R in the X direction.

The arrangement of the first planar mirror 2 and the aspherical mirror 3 will be further described herein. An angle between the line segment QD (representing the optical path of the lowermost incident ray reflected by the aspherical mirror 3 and directed to the second planar mirror 4) and the line PS (representing the optical path of the lowermost incident ray emitted from the projection pupil and directed to the first planar mirror 2) is indicated by β. An angle between the line segment QR (representing a cross section of the aspherical mirror 3) and the line ST (representing a cross section of the first planar mirror 2) is indicated by γ. Each of the angles β and γ is indicated to have a positive value if the vertex representing the angle β or γ is oriented toward the top surface of the projection device 100. Each of the angles β and γ is indicated to have a negative value if the vertex representing the angle β or γ is oriented toward the bottom surface of the projection device 100. A relationship between the angle β and the angle γ is expressed by a following formula (3).

β=2γ (3)

When β<−ω, the line segment PS is located on the rear side of the projection device 100 with respect to the line segment SR, and the line segment PS and the line segment RQ intersect. In such a case, the aspherical mirror 3 is inserted in the optical path of light directed from the exit pupil position P toward the first planar mirror 2 and part of the light is blocked by the aspherical mirror 3.

In order to prevent the occurrence of such shading, the first planar mirror 2 and the aspherical mirror 3 may be arranged to meet a following formula (4).

γ≧−ω/2 (4)

Hereinafter, concrete configuration of the projection device 100 to meet the formula (4) will be described.

When optical path of the projection device 100 on the X-Y cross section is developed on the X-Y coordinate system with the point P as an origin, the X-Y coordinate (x, y) of each of the points A, B and F is defined as follows:

A (0, 0);

B (0, h); and

F (w, 0),

where h represents the height of the screen 5 and w represents the depth of the projection device 100.

When lengths of the line segments P′C, P′R and RF are indicated by i, m and k, respectively, the lengths w and k are given by the following formulae (5) and (6):

w=i×sin ω (5), and

k=m×sin ω (6).

If the projection device 100 is configured to meet the following condition (a), the aspherical mirror 3 can be accommodated within an area ABEF, which is defined depending on the size of the screen 5.,

(i−m)cos ω≦h (a)

If the condition (a) is not met, the edge of the aspherical mirror 3 (using area) is arranged under the lowermost point of the screen 5 on the X-Z plane. Such a configuration is not preferable since the size of the projection device may be upsized.

The line segment RQ is defined with a following formula (7).

y=(x−(w−k))/tan α) (7)

According to the formula (7), the X-Y coordinate of the point Q is represented as follows.

Q (w, k/tan α)

In FIG. 2, the line segment SQ and line segment FQ are symmetrical with respect to the line segment QR. Therefore, ∠SQR and ∠SQF are given by following formulae (8) and (9).

∠SQR=∠FQR=α (8)

∠SQF=2α (9)

According to the formulae (8) and (9), the line segment SQ is given by a formula (10).

y=(x−w)/tan 2α+k/tan α (10)

The line segment CR is given by a formula (11) in accordance with the above mentioned formulae.

y=h−x/tan ω (11)

A point at the intersection of the line segment SQ with the line segment CR (i.e., the point S of which the X-Y coordinate is (Sx, Sy)) is obtained from the above formulae (10) and (11).

Sx=(w/tan 2α−k tan α+h)(1/tan 2α+1/tan ω)

Sy=h−Sx/tan ω

An inclination of the line segment ST is equal to Sy/Sx, since the point T corresponds to the origin A. Thus, the inclination of the line segment ST is obtained from a following formula (12).

Sy/Sx=h/Sx−1/tan ω (12)

A following formula (13) is derived based on the formula (4).

1/tan(α+γ)≦1/tan(α−2/ω) (13)

A left side term of the formula (13) is equal to Sy/Sx (the inclination of the line segment ST). Therefore, the formula (13) can be modified to a formula (14), and further modified to a formula (15) as follows.

h/Sx−1/tan ω≦1/tan(α−ω/2) (14)

h/Sx≦(1/tan(α−ω/2)+1/tan ω) (15)

A following condition (b) is derived by substituting the above obtained Sx to the formula (15).

$$\frac{h}{\frac{i sin ω}{tan 2 α} - \frac{m sin ω}{tan α} + h} \leq \frac{\frac{1}{tan ( α - \frac{ω}{2} )} + \frac{1}{tan ω}}{\frac{1}{tan 2 α} + \frac{1}{tan ω}} \qquad ( b )$$

If the condition (b) is maintained, the first planar mirror 2 and the aspherical mirror 3 can be arranged with maintaining the projection device 100 to be thin and compact, and with preventing the blocking of light by the aspherical mirror 3. If the condition (b) is not met, a part of the aspherical mirror 3 is inserted in the optical path of light directed from the exit pupil P to the first planar mirror 2.

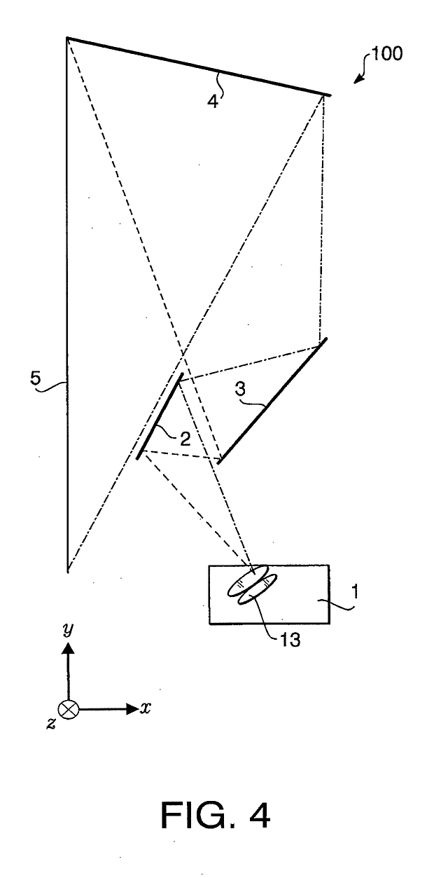

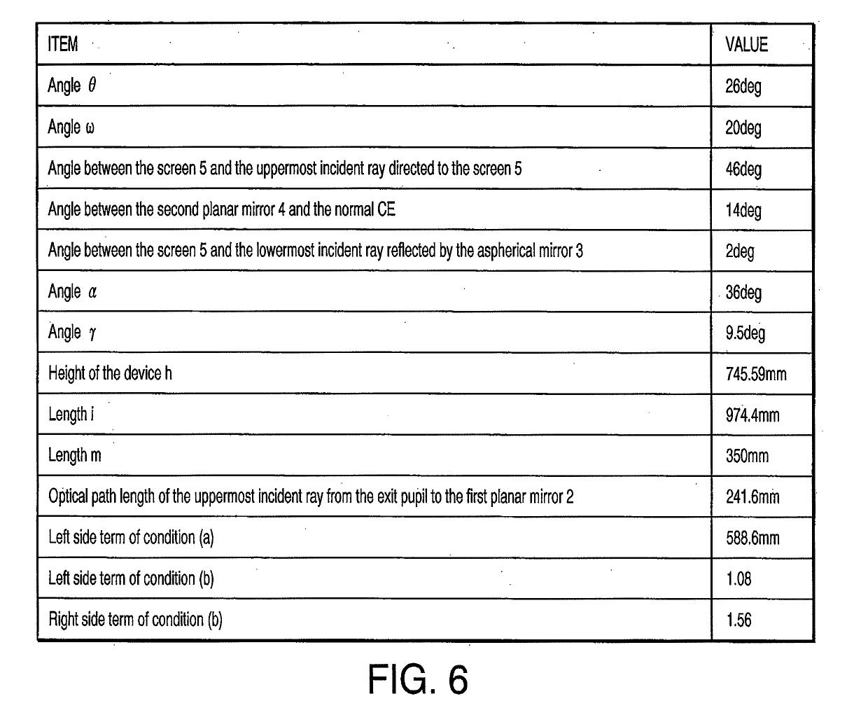

Hereinafter, a concrete example of the projection device 100 according to the embodiment will be described. FIG. 4 is a cross-sectional side view, take along the X-Y plane, of the projection device 100 according to the present embodiment. In order to simplify the drawing, the light source 11, the image generating unit 12 and casing 50 are omitted in FIG. 4. The specific parameters of the projection device 100 shown in FIG. 4 are listed in a Table shown in FIG. 6.

As shown in the Table in FIG. 6, the angle between the second planar mirror 4 and the normal line segment CE is set to 14 degrees (1 degree being added, as a margin, to θ/2). Accordingly, the aspherical mirror 3 does not interfere with the rear wall of the casing 50, regardless of ribs and thickness of the aspherical mirror 3.

Further, it is known from the Table that the left side term of the condition (a) is 588.6 and the right side term of the condition (a) (i.e., height h) is 745.59. Therefore, the condition (a) is satisfied, and the incident position of the uppermost incident ray on the aspherical mirror 3 is higher than the X-Z plane including the lowermost point of the screen 5, which contributes to downsizing of the projection device 100.

It is also know from the Table that the left side term of the condition (b) is 1.08 and the right side term of the condition (b) is 1.56. Therefore, condition (b) is also satisfied. When the first planar mirror 2 is arranged such that the point S is substantially on the line segment CR (i.e., the optical path of the uppermost incident ray reflected by the aspherical mirror 3), if the left side term is equal to the right side term of the condition (b), the position P′ of the exit pupil is located at its uppermost position (i.e., the position closest to the second planar mirror 4) on the plane of FIG. 2. Accordingly, the size of the lower part of the projection device indicated by a reference numeral 6 in FIG. 1 (which is a part lower than the lowermost part of the screen 5) can be reduced. When the first planar mirror 2 is arranged such that the point S is spaced from the line segment CR, even if the angle γ is made slightly smaller than ω/2, the light reflected by the aspherical mirror 3 is not blocked by the first planar mirror 2. Therefore, the size of the lower part 6 of the projection device 100 can be further reduced. In a particular case, depending on the configuration, the size of the lower part 6 may be minimized (i.e., a projection device without frames may be configured).

Although an example of carrying out the invention have been described above, the present invention is not limited to the above described embodiment and various modification can be made without departing from the scope of the claims.

An example of such modifications will be described referring to FIG. 5. FIG. 5 shows, similarly to FIG. 3, an arrangement of optical elements of a projection device 200 with the entire optical path being developed. As shown FIG. 5, the projection device 200 is provided with substantially the same configuration of the projection device 100 except that, instead of the aspherical mirror 3, an aspherical mirror 3a is employed. The aspherical mirror 3a has a shape which is a marginal part of a concave mirror indicated by 3a′ in FIG. 5.

Specifically, the aspherical mirror 3a has a linear shape on the X-Y plane and a concave shape on the X-Z plane. The aspherical mirror 3a is concave toward the second planar mirror 4. By employing such an aspherical mirror 3a, an astigmatic difference caused by the aspherical mirror 3a can be suppressed.

The present disclosure relates to the subject matter contained in Japanese Patent Application No. P2006-180606, filed on Jun. 30, 2006, which is expressly incorporated herein by reference in its entirety.

What is claimed is:

1. A projection device, comprising:
an upright screen on which an image is projected, the upright screen extending in a vertical direction in a normal usage state;
an image projection unit configured to emit light carrying an image to be projected on the upright screen, the image projection unit being arranged behind a lower portion of the upright screen to emit the light toward the upright screen;
a first mirror arranged to reflect the light emitted by the image projection unit such that the reflected light proceeds in a direction away from the screen;
a second mirror arranged to reflect the light reflected by the first mirror toward an upper wall of the projection device, the second mirror has an optical power; and
a third mirror arranged on an inner surface of the upper wall of the projection device, the third mirror reflecting the light reflected by the second mirror to the upright screen from behind,
wherein an optical path, in a cross section taken on a plane which extends vertically, perpendicular to the upright screen and intersecting with the upright screen at the center thereof, between the second mirror and the third mirror, of a light ray that is incident on the lowermost position of the upright screen is substantially parallel to the upright screen.

2. The projection device according to claim 1, wherein the second mirror is configured to compensate for aberrations.

3. The projection device according to claim 1, wherein an angle between the third mirror and a normal to the upright screen is (θ/2)±1 degrees, where θ represents an angle formed between the upright screen and the lowermost light ray incident on the upright screen.

4. The projection device according to claim 1, wherein the first mirror is arranged between the second mirror and the upright screen in the cross section.

5. The projection device according to claim 1, wherein a condition:
(i−m)cos ω≦h
is satisfied,
where, i represents an optical path length, on the cross section, of a light ray incident on the uppermost position on the upright screen, from an exit pupil of the image projection unit to the third mirror,
m represents an optical path length, on the cross section, of the light ray that is incident on the lowermost position on the upright screen, from an exit pupil of the image projection unit to the third mirror,
ω represents an difference of an angle formed between the upright screen and the light ray incident on the uppermost position on the upright screen, and an angle formed between the upright screen and the light ray incident on the lowermost position on the upright screen, and
h represent a height of the upright screen.

6. The projection device according to claim 1,
wherein the first mirror is arranged, on the cross section, such that a position on the first mirror where the light ray incident on the lowermost position of the upright screen is incident is farther from the upright screen than a position on the first mirror where the light ray incident on the uppermost position of the upright screen is incident, and
wherein the second mirror is arranged, on the cross section, such that a position on the second mirror where the light ray incident on the lowermost position of the upright screen is incident is farther from the upright screen than a position on the second mirror where the light ray incident on the uppermost position of the upright screen is incident.

7. The projection device according to claim 1, wherein a following condition:
$$\frac{h}{\frac{i sin ω}{tan 2 α} - \frac{m sin ω}{tan α} + h} \leq \frac{\frac{1}{tan ( α - \frac{ω}{2} )} + \frac{1}{tan ω}}{\frac{1}{tan 2 α} + \frac{1}{tan ω}}$$
is satisfied,
where, i represents an optical path length, on the cross section, of a light ray incident on the uppermost position on the upright screen, from an exit pupil of the image projection unit to the third mirror,
m represents an optical path length, on the cross section, of the light ray that is incident on the lowermost position on the upright screen, from an exit pupil of the image projection unit to the third mirror,
ω represents an difference of an angle formed between the upright screen and the light ray incident on the uppermost position on the upright screen, and an angle formed between the upright screen and the light ray incident on the lowermost position on the upright screen,
h represent a height of the upright screen, and
α represents an angle, on the cress section, between the second mirror and the light ray, that is incident on the lowermost position on the upright screen, incident on the second mirror.

8. The projection device according to claim 1, wherein the image projection unit includes:
a light source;
an imge generating unit that generates the light carrying information of image to be projected using the light emitted by the light source being incident on the image generating unit; and
a projection optical system that projects the light carrying information of image generated by the image generating unit onto the upright screen.

9. The projection device according to claim 2, wherein the first mirror and the third mirror are planar mirrors.

10. The projection device according to claim 2, wherein the second mirror is an aspherical mirror.

11. The projection device according to claim 10,
wherein the second mirror is configured such that, within an area on which the light reflected by the first mirror is incident, the shape of the second mirror, in the cross section, is linear, and the shape of the second mirror, on a plane parallel with the upright screen is curved toward a direction in which the light by the second mirror proceeds.

12. The projection device according to claim 10,
wherein the second mirror is configured such that, within an area on which the light reflected by the first mirror is incident, the shape of the second mirror, in the cross section, is linear, and the shape of the second mirror, on a plane parallel with the upright screen is curved toward a direction opposite to a direction in which the light reflected by the second mirror proceeds.
